(19) United States
(12) Patent Application Publication
(10) Pub. No.: US 2019/0374438 A1
(43) Pub. Date: Dec. 12, 2019

(54) BREASTFEEDING SUPPORTING SYSTEM AND CORRESPONDING METHOD

(71) Applicant: KONINKLIJKE PHILIPS N.V., EINDHOVEN (NL)

(72) Inventors: Kiran Hamilton J. DELLIMORE, UTRECHT (NL); Maria Estrella MENA BENITO, EINDHOVEN (NL); Calina CIUHU, EINDHOVEN (NL); Igor Wilhelmus Franciscus PAULUSSEN, NUENEN (NL); Cornelis Petrus HENDRIKS, EINDHOVEN (NL); Yannyk Parulian Julian BOURQUIN, EINDHOVEN (NL); Lili-Marjan BROCKHUIS, GELDROP (NL)

(21) Appl. No.: 16/481,870

(22) PCT Filed: Jan. 31, 2018
(86) PCT No.: PCT/EP2018/052406

§ 371 Date: Jul. 30, 2019

(30) Foreign Application Priority Data
Feb. 2, 2017 (EP) 17154374.7

(51) Int. Cl. A61J 13/00

(52) U.S. Cl. CPC A61J 13/00; A61J 2200/70

(57) ABSTRACT

A breastfeeding supporting system and a corresponding method are disclosed, the breastfeeding supporting system (1) comprising a nipple shield (10) adapted to be positioned at least partly over the areola and nipple of a breast of a breastfeeding woman, a capacitive pressure sensing unit (20) for sensing a capacity of at least part of a surface of the nipple shield, a processing unit (40) adapted to process the sensed surface capacity to derive at least one parameter of an infant interacting with the nipple of the breastfeeding woman. The breastfeeding supporting system and corresponding method eliminate at least some concerns related to breastfeeding.

### FIELD OF THE INVENTION

The present invention relates to a breastfeeding supporting system and a corresponding method. The present invention relates in particular to a breastfeeding supporting system comprising an instrumented nipple shield to support breastfeeding.

### BACKGROUND OF THE INVENTION

For human and other mammalian babies breast milk is the optimal nutrition since in addition to containing water and nutrients to promote growth, it also contains antibodies which protect the baby from infections. The best way for an infant to obtain breast milk is via breastfeeding, in which the baby suckles at the mother's nipple to extract the breast milk. Despite the various advantages of breastfeeding, new mothers may still be unsure whether or not to breastfeed their baby due to various concerns.

For instance, it is known that in case the baby is not positioned properly, the breast might not be stimulated to produce sufficient milk, the infant may not be getting enough breast milk which leads to further problems to the infant and the mother in the consequence. In addition to poor nipple latching, i.e. an improper positioning of the baby and ineffective latching to the nipple, concerns include tongue tie and uncertainties over the baby's feeding state. Tongue tie, which generally refers to a decrease in mobility of the tongue of the infant, can lead to nipple soreness and pain for the mother as well as breastfeeding difficulty for the baby and is generally difficult to diagnose and detect. The baby's feeding state can present another uncertainty since it is challenging to know whether the infant is feeding or playing with the nipple. Finally, a major challenge encountered in particular with premature babies, i.e. babies born before 38 weeks of gestation, is that they can lack the necessary suction strength for breastfeeding, wherein it is challenging to assess whether a baby is strong enough to breastfeed or not.

Current approaches necessitate the intervention of trained consultants and/or clinical experts, or concern mitigation strategies, in particular to alleviate nipple pain and soreness caused by tongue tie or poor latching. This includes the use of nipple shields, which allows a mother to continue breastfeeding when her nipples are sore or painful, without identifying the cause of the condition.

### SUMMARY OF THE INVENTION

It has therefore been an object of the present invention to provide an improved breastfeeding supporting system and a corresponding method, which eliminate at least some of the concerns discussed above.

In a first aspect of the present invention a breastfeeding supporting system is provided. The breastfeeding supporting system comprises a nipple shield adapted to be positioned at least partly over the areola and nipple of a breast of a breastfeeding woman, a capacitive pressure sensing unit for sensing a capacity of at least part of a surface of the nipple shield, an accelerometer unit for measuring an acceleration of the nipple shield and a processing unit adapted to process the sensed capacity and the measured acceleration of the nipple shield to derive at least one parameter of an infant interacting with the nipple of the breastfeeding woman.

Since the capacitive pressure sensing unit is configured to sense a capacity of at least a part of the surface of the nipple shield, and since the capacity is influenced by the presence of nearby elements, such as the infant, the breastfeeding supporting system according to the invention can advantageously determine parameters of the infant which provide valuable information for breastfeeding.

The accelerometer unit allows to measure nipple movement and based thereon determine tongue tie, e.g. due to reduced mobility, quantitatively during breastfeeding. In combination with the sensed pressures the accelerometer sensors allow for an enhanced breastfeeding supporting system. In an embodiment the accelerometer unit comprises multiple accelerometer sensors, which allow a spatially resolved determination of the accelerations. The accelerations are preferentially determined in the nipple section of the nipple shield, wherein in other embodiments additionally or alternatively accelerations of other parts of the nipple shield not forming the nipple section can be determined.

Exemplarily, during a correct latching, the nipple can move in a symmetric way in the axial plane, while asymmetric movement may be present in the sagittal plane. An asymmetric movement in the axial plane would typically be a sign of bad latching. This can be detected and advantageously evaluated using the accelerometer unit.

Preferentially, the parameter includes a position and at least part of a shape of a mouth of the infant interacting with the nipple. Further preferentially, the position is indicative of a latching position, i.e. suitable for determining whether the infant's latching is effective or not, and the shape of the mouth is indicative of a tongue tie condition, i.e. whether a critical medical condition which needs treatment is present. While these parameters are examples for parameters that can advantageously be employed for supporting breastfeeding, also other parameters can suitably be used in other embodiments.

The infant's interaction with the nipple preferentially includes catching, suckling and/or latching.

Preferably, the capacitive pressure sensing unit comprises a swept frequency capacitive pressure sensor for carrying out the capacitive sensing using alternating current with various frequencies, as known in the art.

The nipple shield preferentially comprises a soft, flexible, non-allergenic, polymer material, such as, without being limited to the example, silicone. Preferentially, the nipple shield comprises a nipple shield base arranged to cover the areola and a nipple section including at least one hole to cover the nipple. For instance, the nipple shield can be in the form of one of publically available nipple shields.

Preferentially, the capacitive pressure sensing unit and/or the processing unit can be embedded within the nipple shield, such that the entire system can be provided having the appearance and shape of the nipple shield. It is preferred for the embedded elements not to protrude from the surface of the nipple shield to minimize distraction and influence on the breastfeeding.

In an embodiment the processing unit is configured to derive a position of the mouth of the infant latching on the nipple of the breastfeeding woman as one of the parameters and to evaluate the position with respect to a correct position. By evaluating the position with respect to a correct position, deviations from the correct position, i.e. indicative of poor latching of the infant on the nipple, can be determined. In one embodiment, it can be assumed that a correct latching position corresponds to the pressure being approximately centered on the nipple, while in other embodiments also other positions, such as previously recorded and/or calibrated latching positions, can be considered as a reference for the correct latching position.

Preferably, the correct latching can be determined during at least one of two different moments of breastfeeding. The first is the moment when the baby first catches (and secures) the nipple in its mouth, and the other is when the baby is suckling at the nipple to extract breast milk. When the baby first catches the nipple in its mouth, typically, it is expected that a portion of the nipple and areola will be trapped in the mouth of the baby. This portion depends on the size of the nipple and areola. The correct position may thus be assessed by measuring the portion of the nipple and areola in the mouth of the baby to the portion out of the mouth of the baby, as the portion in the mouth would be deformed in a specific manner. Additionally, this deformation is in a normal case symmetric in the sagittal plane, i.e. an anatomical plane dividing the body into right and left halves, and asymmetric in the axial plane, i.e. a plane dividing the body horizontally when upright.

During suckling, the correct positioning of the baby is preferentially determined based on the asymmetry of the pressure distribution exerted by the baby's lips and tongue on the base, shaft and tip of the nipple shield and the position as well as movement of the tongue in relation to the nipple.

During nutritive suckling the compressive pressure (force) exerted by the baby's lips on the nipple shield should be initially uneven with a slightly higher pressure (force) exerted on the base of the nipple than on the middle and tip of the nipple thereby enabling ‘pinching off’ of milk within the ducts of the nipple (teat) during suckling. As the baby extracts the milk during a suckling cycle the higher pressure applied by the tongue to the nipple then shifts posteriorly from the base of the nipple, along the nipple shaft to the nipple tip (similar to a compression wave). In addition, for successful latching the tongue should form a substantially U shaped half-channel around the lower portion of the nipple during feeding. Exemplarily, it should be also noted that typical tongue forces exerted during successful latching are on the order of 2-3 N.

During non-nutritive suckling, nipple playing and incorrect latching of the baby different pressure distributions and tongue positions may occur and these can be identified by the degree to which they deviate from the above described correct latching and tongue positioning, as well as by the pressure (force) magnitude. Playing with the nipple or poor latch may for example be identified by application of higher pressure at the incorrect portion of the nipple shaft during a suckling cycle and by the absence of a compression wave acting in a posterior direction. Instead the tongue may move in a side to side or up and down direction. Also, if too little or too high pressure is exerted by the tongue or lips on the nipple this can also be used to indicate improper latching. Additionally, the nipple may not be properly fixed within the mouth of the baby leading to change in the portion of the nipple in the mouth of the baby during the suckling. In the event that poor latching occurs a feedback signal can be generated which is indicative of the status of nipple latching and which is provided to a mother via a feedback unit, for instance to assist her in adjusting the baby's mouth to an appropriate position for more effective suckling. It is important that a mother does not persist in breastfeeding with an incorrect latch-on in order to avoid painful and sore nipples. The baby should be immediately taken off and latching should be restarted.

In an embodiment the capacitive pressure sensing unit comprises a capacitive sensor array. The array allows for an improved spatial resolution of the capacitive sensing and therefore increases the accuracy of the determined parameter of the infant and the breastfeeding supporting system.

In an embodiment the capacitive sensor array is arranged around the circumference of the nipple shield. Arranging the capacitive pressure sensing unit around the circumference of the nipple shield allows spatially resolving the sensed capacities and therefore the underlying pressure and proximity of tissue in a circumferential direction. For example, deviations from a centered pressure pattern can be indications for a poor latching of the infant.

In an embodiment the accelerometer unit is embedded in a wall of the nipple shield.

Since the accelerometer unit is embedded within the nipple shield, the surface which gets into contact with skin of the breastfeeding woman or the infant remains soft and flexible and is not disturbed by the accelerometer unit. The wall of the nipple shield is preferentially a wall of the nipple section, i.e. the part of the nipple shield which is intended to cover the nipple. However, in other embodiments, also the remaining portions of the nipple shield can be employed for embedding the accelerometer unit.

In an embodiment the nipple shield comprises a visible orientation indication, wherein the accelerometer unit has a predetermined orientation relative to the visible orientation indication.

Since the orientation of the accelerometer unit with respect to the visible orientation indication is predetermined and thus known, the sensed accelerations can be evaluated taking advantage of the known relative orientation. The visible orientation indication can comprise, for instance, a colored mark, a deformation and the like which distinguishes the visible orientation indication from the rest of the surface of the nipple shield.

In an embodiment the visible orientation indication is visible by the breastfeeding woman in case the nipple shield is positioned correctly on the areola.

Preferentially, the breastfeeding woman can determine whether the nipple shield is positioned correctly by looking at the visible orientation indication, wherein the breastfeeding woman does not necessarily see the visible orientation indication when the nipple shield is not positioned correctly. Preferentially, the visible orientation indication thus indicates a position which is designated to be located on the upper side of the nipple shield when positioned on the areola. Advantageously, the breastfeeding woman thus does not need a mirror or the like to determine whether the nipple shield is positioned correctly.

In an embodiment at least one of the capacitive sensors of the capacitive pressure sensing unit and the accelerometer unit comprises a microelectromechanical systems (MEMS) based sensor component.

MEMS based sensor components are well-known examples of sensing units which can be provided at a size that is suitable for embedding within the nipple shield of the breastfeeding supporting system according to the invention. Each of the capacitive pressure sensing unit and/or the accelerometer unit can comprise a particular processing unit which interacts with sensor components interacting with the surroundings and measuring capacities and accelerations, respectively. However, in further embodiments, the capacitive pressure sensing unit and/or the accelerometer unit can also only comprise sensing components and communicate raw sensed values directly to the processing unit of the breastfeeding supporting system. In some embodiments the capacitive pressure sensing unit and/or the accelerometer unit can comprise a dedicated driving component for driving the respective sensors, while in other embodiments the capacitive pressure sensing unit and/or the accelerometer unit are driven by the processing unit of the breastfeeding supporting system. While MEMS based sensor components are provided as examples for the capacitive pressure sensing unit and/or accelerometer unit, in other embodiments also different sensor components can be employed.

In an embodiment none of the capacitive sensor unit, the accelerometer unit and the processing unit protrudes from the surface of the nipple shield.

Preferentially, the nipple shield comprises a silicon material, which is flexible and has little influence on the baby's feeding. Since no element protrudes from the surface of the nipple shield, influence on the infant's feeding is minimized and the feeding process is maintained as natural as possible.

In an embodiment the processing unit is configured to determine, based on the sensed surface capacity and the determined accelerations, at least one of i) a shape of the mouth of the infant latching on the nipple, ii) a quantitative measure of tongue tie of the infant and iii) a movement of the tongue of the infant.

The processing unit thereby allows for determining parameters which can indicate at least one of poor nipple latching, tongue tie, inadequate suction strength and the baby's feeding state based on the sensed surface capacities and the determined acceleration. Thereby, the breastfeeding supporting system according to the invention allows for addressing common concerns related to breastfeeding using the derived parameters. The infant's feeding state can be an indication as to whether the infant is still feeding or not. For instance, based on movement of the nipple detected by the accelerometer unit it can be determined whether the infant is feeding or rather playing with the nipple, so that the mother can know when to stop breastfeeding.

In an embodiment the breastfeeding supporting system further comprises a feedback unit for providing a feedback signal to the breastfeeding woman.

Since the feedback unit provides a feedback signal to the breastfeeding woman, the breastfeeding woman receives feedback which can support and facilitate her breastfeeding. In some embodiments the feedback signal can be an optical or acoustical feedback signal provided directly on the nipple shield. In further embodiments, the feedback unit can comprise a transmission component, wherein the feedback signal is transferred from the transmission component to a reception component and provided distant from the nipple shield, in order to reduce the impact on the feeding of the infant through, for instance, optical or acoustical disturbances.

The feedback signal is preferentially generated based on the sensed surface capacity and the determined accelerations processed by the processing unit. In other examples, the feedback signal comprises the sensed surface capacity and/or acceleration data.

In an embodiment the feedback signal is indicative of at least one of i) status of nipple latching, ii) tongue tie, iii) the infant's feeding state and iv) suction strength. Thereby, the feedback signal can address and be indicative for various of the major concerns related to breastfeeding.

Preferably, the feedback signal indicates whether poor or incorrect latching occurs. The feedback signal may then assist the breastfeeding woman in adjusting the baby's mouth to an appropriate position for more effective suckling. It is important that a mother does not persist in breastfeeding with an incorrect latch-on in order to avoid painful and sore nipples. The baby should be immediately taken off and latching should be restarted.

In an embodiment the feedback unit comprises a wireless transmission component for wirelessly transmitting at least the feedback signal.

Accordingly, no wires need to be connected to the nipple shield for transmitting the feedback signal, which makes the breastfeeding supporting system less cumbersome to use. The wireless transmission component can comprise any component capable of transmitting signals wirelessly, such as a component including Bluetooth, ZigBee, Wi-Fi and so on.

In an embodiment the breastfeeding supporting system further comprises a user interface device for wirelessly receiving the feedback signal from the wireless transmission component and for providing a signal to the breastfeeding woman corresponding to the feedback signal.

The user interface device in this embodiment is any device capable of receiving the wirelessly transmitted feedback signal, such as, including but not limited to, smart phones, tablet computers, smart watches and smart glasses. Preferentially, the user interface device is capable of executing an application, which processes the received feedback signal and displays information corresponding to the received feedback signal to the user. In a preferred embodiment, real-time audio-visual feedback on the latching, a position of the soft-palate of the baby relative to the nipple shield, a tongue state and suction strength of the baby can be provided.

One example of an application suitable for displaying the feedback is the uGrow App, while also other Apps can be employed in other embodiments. Alternatively or additionally, other information can be provided via the feedback path, such as a pressure distribution on the nipple, a magnitude of the pressure and a movement of the nipple, i.e. the sensed pressures and/or accelerations. Additionally or alternatively, this information can also be displayed via the user interface device. The user can then adjust the placement of the baby based on the indicated feedback to ensure that the baby be optimally placed for receiving the breast milk.

In an embodiment the wireless transmission component is configured to transmit the feedback signal in case the capacitive pressure sensing unit senses capacity variations only.

Since the wireless transmission component only transmits signals in case the capacitive pressure sensing unit senses capacity variations, i.e. varying pressure is applied on the nipple shield being indicative of the breastfeeding supporting system being in use and the baby being in contact with the nipple, power can be saved whenever the breastfeeding supporting system is not in use. Expressed differently, the device can be described as being event-based powered only, thereby increasing the efficiency of the breastfeeding supporting system.

In an embodiment the breastfeeding supporting system comprises a learning unit for correlating the feedback signal with a marker indicative of a well-being of the infant or the mother, and for deducing a quality of latching, suckling and/or positioning of the baby based on the correlation.

The feedback signal can comprise all the data described with respect to above described embodiments including raw sensed data or processed data.

Preferably, a marker indicative of a well-being of the baby can include weight intake and a general condition, while a marker indicative of a well-being of the mother can include a breast condition.

Preferably, the markers indicative of well-being can be provided, e.g. input, via the user interface device, such as a smartphone executing the uGrow App in one example. The user interface device, or a different unit, e.g. a server, can comprise storage means for storing weight data and a growth curve of the baby. A determined correct latching position can then preferably be confirmed with a weight gain of the baby and/or the following of a typical growth curve over time. Further preferably, when poor latch is detected, the baby will not gain weight and will not grow at a normal rate as a result of not receiving sufficient milk containing vital nutrients. This embodiment may further help support the feedback and guidance to the mother to achieve a more optimal latch of the baby.

In an embodiment the breastfeeding supporting system further comprises a power providing unit for providing power.

Preferentially, the power providing unit comprises a button cell battery and/or a wireless energy reception means. In other embodiments, also other means for providing power to the breastfeeding supporting system are contemplated.

In an embodiment the power providing unit comprises an energy harvesting unit for mechanically harvesting energy from the nipple movement during suckling of the infant.

By harvesting energy from the nipple movement, the breastfeeding supporting system can be powered autonomously without having to provide, for instance, a dedicated battery or power reception means. Preferentially, the energy harvested from accelerations on the nipple is sufficient to power both the sensors and wireless data transmission.

In an embodiment the breastfeeding supporting system further comprises a stimulation unit for providing at least one of acoustical and optical stimuli, the stimuli preferentially comprising recorded sounds or videos of the infant, wherein the stimulation unit is configured to provide stimuli in reaction to a trigger event.

It is known that, for instance, sounds of the baby such as crying, gurgling or babbling can help stimulating milk ejections and thus help improving the volume of milk collected during expression. The stimulation unit can, in one embodiment, be a smart phone, tablet and the like and be implemented, for instance, in the same device as the user interface device. Preferentially, the stimuli are provided in reaction to a trigger event, such as a pressure being recorded by the capacitive pressure sensing unit. Of course, also other trigger events such as based on the time of the day and/or patterns of the mother can be used. In an embodiment the time of the day and the patterns of the mother are observed and relevant playlists, such as based on the recorded sounds of the infant, can be proposed to promote milk production.

In an embodiment the breastfeeding supporting system further comprises a breast pump, wherein a vacuum profile of the breast pump is configured to be adjusted based on the derived at least one of the position and the shape of the mouth of the infant.

Preferentially, the parameter is at least one of a position and a shape of the mouth of the infant, such that the vacuum profile of the breast pump corresponds to the baby when suckling. Even further preferred, the vacuum profile is also adjusted based on accelerations sensed by the accelerometer unit, in order to more accurately mimic the baby's suckling. Preferentially, the vacuum profile can be updated as the baby is growing, thereby modifying the pump suction pattern, in order to more accurately correspond to the baby's suckling behavior.

In an embodiment the breastfeeding supporting system further comprises a data storage unit for storing permanent and temporary data.

The data storage unit can thereby store permanent data, e.g. control commands for controlling the processing unit, and temporary data, e.g. acquired capacitance data and accelerometer data. Preferentially, the permanent data are not erased in case of an interrupted power supply to the breastfeeding supporting system.

In an embodiment the breastfeeding supporting system further comprises a power switch. The power switch is preferably provided together with the nipple shield, for instance embedded therein. In some embodiments the power switch is realized in the form of a switch or button, in other embodiments the power switching can be implemented through gestures and/or deformations actuated on the nipple shield, such as bending or twisting the nipple shield.

In a further aspect a breastfeeding supporting method is provided. The breastfeeding supporting method comprises providing a sensed capacity of at least part of a surface of a nipple shield positioned on a nipple of a breastfeeding woman, providing a measured acceleration of the nipple shield, and processing the sensed capacity and the measured acceleration of the nipple shield to derive at least one parameter of an infant latching on the nipple of the breastfeeding woman.

Preferably, the method can be implemented in the form of a computer program comprising program code means for causing a processing unit of a system to carry out the steps of the breastfeeding supporting method as defined in claim 15, when the computer program is run on the system. Further preferably, the processing unit can be one of or a combination of the processing unit of the breastfeeding supporting system as defined in claim 1 and/or the processing unit of a user interface device, such as a smart phone or a tablet computer. In one embodiment the computer program is provided in the form of an App to be run on the user interface device.

It shall be understood that the system of claim 1 and the method of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily an embodiment of a nipple shield of the breastfeeding supporting system according to the invention,

FIG. 2 shows schematically and exemplarily an embodiment of the breastfeeding supporting system according to the invention,

FIG. 3 shows a flowchart exemplarily illustrating an embodiment of a breastfeeding supporting method, and

FIGS. 4A-4F show schematically and exemplarily the general anatomy of suckling of an infant.

### DETAILED DESCRIPTION OF EMBODIMENTS

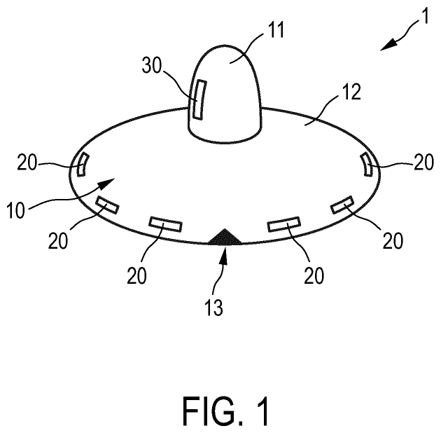

FIG. 1 shows schematically and exemplarily an embodiment of a nipple shield 10 of a breastfeeding supporting system 1 according to the invention. In this example, a nipple shield 10 is of a well-known shape of a nipple shield and comprises a soft, flexible, polymer material, such as silicon. Nipple shield 10 comprises a nipple section 11 including at least one hole for expressing breast milk from a female breast and a nipple shield base 12 arranged to cover the areola. On one side of nipple shield 10 a visible orientation indication 13 in the form of a triangle is provided, which is to be positioned on the top of the breast of the woman when using breastfeed supporting system 1, so that visible orientation indication 13 is visible without the use of, for instance, a mirror. Of course can other shapes and/or other materials and/or other orientation indications as known in the art be readily used for the nipple shield 10 in other examples.

In order to assess the latching and positioning of a baby on the nipple, a suction strength and the baby's feeding state, breastfeeding supporting system 1 provides nipple shield 10 with additional instruments, which are in this example embedded within nipple shield 10 such that none of the additional instruments protrudes from the silicon and could potentially interfere with the breastfeeding of the baby.

In this example, an array of capacitive pressure sensors 20, such as microelectromechanical systems (MEMS) capacitive pressure sensors, is arranged along a circumference of nipple shield base 12 along with a MEMS accelerometer unit 30 embedded in nipple shield 10 closed to nipple section 11. While in this example both accelerometer unit 30 and the capacitive pressure sensors 20 are embedded within nipple shield 10, in other examples also only one or some of these elements can be embedded within the soft material, while the remaining elements can then also protrude from nipple shield 10. Also the number and arrangement of pressure sensing unit 20 and accelerometer unit 30 is exemplarily in the example of FIG. 1, in other examples more or less of these elements can be provided which can also be arranged in a different pattern.

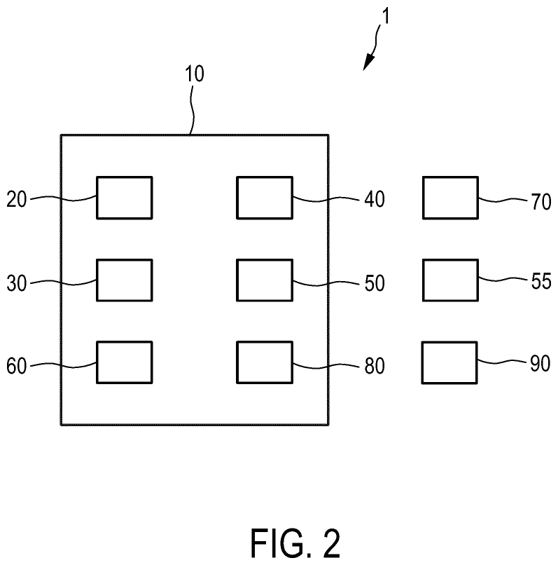

FIG. 2 shows schematically and exemplarily an embodiment of breastfeeding supporting system 1 of FIG. 1 in further details. Nipple shield 10 is in this example depicted schematically with capacitive pressure sensors 20, accelerometer unit 30 and further a processing unit 40, a feedback unit 50, a power providing unit 60 and a data storage unit 80 embedded therein. Breastfeeding supporting system 1 further comprises a stimulation unit 70, a learning unit 90 and a user interface device 55, which are in this example provided distant from nipple shield 10 and communicate with the elements provided within nipple shield 10 by means of a wired or wireless connection.

Processing unit 40 is in this example arranged to communicate with capacitive pressure sensing unit 20, accelerometer unit 30, and data storage unit 80. Further, processing unit 40 receives power from power providing unit 60, which provides all components with electrical power. Finally, processing unit 40 is configured to communicate with feedback unit 50 comprising in this example a wireless transmission component for wirelessly transmitting a feedback signal comprising, for instance, information indicative of a status of nipple latching, tongue tie, the infant's feeding state and suction strength. Processing unit 40 can be any means suitable for data processing, such as a processor, which controls data acquisition, storage and transmission.

Processing unit 40 can process the sensed signals by itself and/or transfer the sensed data via feedback unit 50 as a feedback signal, while the processing of the raw data is carried out on the side of user interface device 55 which receives the feedback signal from feedback unit 50.

Power providing unit 60 can in one example be provided in the form of a button cell battery or via other means, such as a wireless energy transfer reception unit. In a preferred example, power providing unit 60 comprises an energy harvesting unit for mechanically harvesting energy during breastfeeding from the sucking action and/or tongue movement of the baby. The energy harvesting unit can comprise a compact linear or rotary alternator and (super-) capacitor or a dielectric silicon electroactive polymer (EAP), pressure or stretch sensor, just to name a few examples.

Feedback unit 50 comprising the wireless transmission component can comprise, for instance, a near field communication (NFC), Bluetooth low energy, low power Wi-Fi or ZigBee transmitter. These are only examples for suitable wireless data transmitters and also other known wireless data transmission components can be employed in other examples. Additionally or alternatively, data transmission may also be accomplished via wired means, for instance, using a bit-serial cable to be connected to a corresponding port of nipple shield 10.

Data storage unit 80 comprises a permanent and temporary data storage, that is configured for storing control commands in the permanent data storage as well as data acquired by capacitive pressure sensing unit 20 and/or accelerometer unit 30 in a temporary's data storage.

Nipple shield 10 can further be provided with a means (not shown) to turn the device on or off, for instance, implemented as a switch or button. Feedback unit 50 is configured to transmit the feedback signal and alternatively or additionally measurement signals sensed by capacitive pressure sensing unit 20 and/or accelerometer unit 30 to user interface device 55 or any other suitable device for further action. User interface device 55 in this example comprises a smart phone, smart watch, Google Glass, tablet, or the like.

User interface device 55 is capable of audio-visual output, for instance via an application such as uGrow, to provide feedback to the mother on the breastfeeding. For instance, the feedback can comprise an indication as to a correct attachment and current nipple position, and can also compare the current feeding with previous feedings.

Instead of being processed by processing unit 40 provided embedded within nipple shield 10, data acquired by capacitive pressure sensing unit 20 and/or accelerometer unit 30 can also be transmitted directly to user interface device 55, wherein a processing unit comprised in user interface device 55 can then be configured to further process the data. Expressed differently, the further processing of the raw sensed data can either be carried out on the side of nipple shield 10 and/or the side of user interface device 55.

User interface device 55 can provide real time audio-visual feedback on the latching, position of the soft palate of the baby to the mother's nipple and breast, a tongue state and suction strength of the baby, such as by displaying a pressure distribution on the nipple, a magnitude of the pressure and a movement of the nipple. In reaction to this feedback, the breastfeeding placement of the baby relative to the nipple can be adjusted to ensure that the baby receives optimal nutrition provided by breast milk. A feeding state of the infant, which can be provided as a feedback signal, can be indicative of whether the infant is becoming tired or no longer feeding, but rather playing with the nipple. This feeding state can be determined, for instance, due to movement of the nipple detected by accelerometer unit 30. Feedback by user interface device 55 can then notify the mother so that she can know when to stop breastfeeding.

Stimulation unit 70 can also be configured to receive capacitive pressure sensor and accelerometer data and play recorded sounds of the mother's baby during milk expression to help stimulate milk ejections or releases. Stimulation unit 70 can in one example be implemented as an app or a feature of another app installed on user interface device 55, such as a smart phone. Sounds of a mother's baby can include cooing, crying, gurgling and babbling and relevant playlists can be proposed by stimulation unit 70 to promote production by observing time of day and patterns of the mother's breastfeeding.

As mentioned, power providing unit 60 comprises in this example an energy harvesting unit, preferably including a dielectric silicon electroactive polymer (EAP) pressure or stretch sensor. Energy harvested during breastfeeding can for instance be estimated based on known physics of milk transfer in breastfeeding:
Frequency of nutritive feeding, f=1 Hz
Tongue force during nutritive feeding, F=2-3 N
Tongue displacement, d=2.5-3.0 mm
Duration of a typical breast feeding session, t=900 s (15 mins)
Power harvested, P=f*F*d=(1 Hz)*(2-3 N)*(0.0025-0.0030 m)=5-18 mW
Energy harvested, E=P*t=(5-18 mW)*(900 s)=4.5-16.2 J

The estimated energy to be harvested during a typical breastfeeding session (lasting on average about fifteen minutes) is thus sufficient to power both the data acquisition and the data transfer by wireless means.

Finally, learning unit 90 can correlate the feedback signal from feedback unit 50 with a marker indicative of a well-being of the infant or the mother, and for deducing a quality of latching, suckling and/or positioning of the baby based on the correlation. Likewise as stimulation unit 70, learning unit 90 can in one example be implemented as an app or a feature of another app installed on user interface device 55, such as a smart phone. The feedback signal can comprise all the data described with respect to above described embodiments including raw sensed data or processed data. A marker indicative of a well-being of the baby can include weight intake and a general condition, while a marker indicative of a well-being of the mother can include a breast condition.

Learning unit 90 is in this example configured to confirm good latching and suckling of the baby with weight gain of the baby and the following of a typical growth curve over time. This can be, for instance, accomplished via an app such Avent's uGrow app which can store the weight data and growth curve of the baby. An infant with poor latch will not gain weight and will not grow at a normal rate since they are not receiving sufficient milk containing vital nutrients. This may help support the feedback and guidance to the mother to achieve more optimal latch of the baby. Learning unit 90 can of course in other examples also deduce additional or alternative information, such as confirming tongue tie or a different condition.

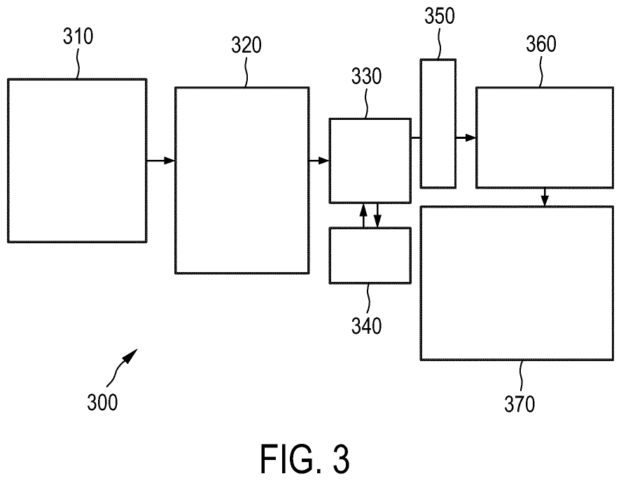

FIG. 3 schematically and exemplarily illustrates a flow chart of a method 300 for supporting breastfeeding. In step 310, an instrumented nipple shield 10 of an appropriate size is selected by the mother to insure a good fit, then switched on and provided on the mother's breast. A symbol or mark on nipple shield 10 can indicate a correct position and orientation.

In step 320, the baby is placed on the breast and allowed to begin feeding. In this step, when the baby's lips attach to the nipple shield 10, capacitive pressure sensing unit 20 acquires data on a pressure distribution applied by the baby's mouth on a nipple shield 10. At the same time, accelerometer unit 30 acquires data on tongue displacement and movement.

In step 330, data acquired in step 320 are provided to processing unit 40 for processing and/or storage.

In a step 350 the data are forwarded to wireless transmission component of feedback unit 50, which wirelessly transfers a feedback signal optionally including the acquired and/or processed data in step 360 to a nearby wirelessly enabled device, such as a user interface device 55.

At the same time processing unit 40 can communicate with a data storage unit 80 in step 340 and transfer data to and/or read data from data storage unit 80.

Data transmitted in step 360 are received by user interface device 55 and in step 370 fed back to the user via an application, such as uGrow, to indicate, for instance, correct attachment and current nipple position. A received feedback signal and/or received data from the capacitive pressure sensors 20 and/or accelerometer unit 30 can be displayed on user interface device 55 and, in some examples, also compared with previous feedings.

Processing of acquired data can be performed on the processing unit 40 side, on the side of user interface device 55 or any arbitrary combination among both. Additionally or alternatively data can be transferred, processed, and/or stored on a server, for instance associated with a user profile.

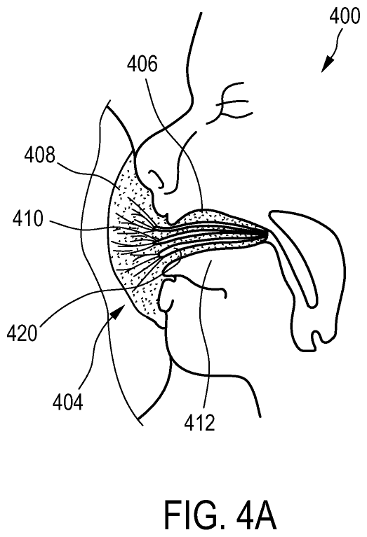

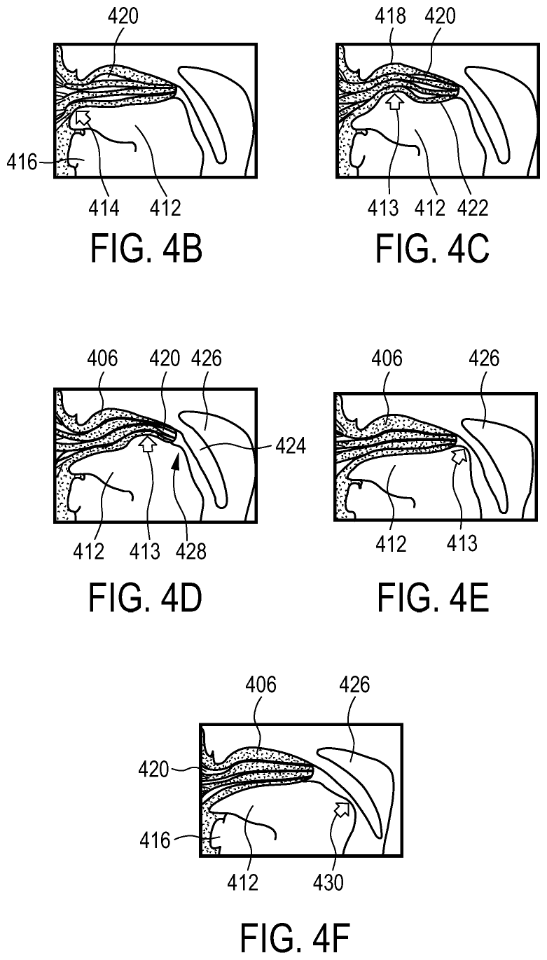

FIGS. 4A-4F shows schematically and exemplarily the general anatomy of suckling of an infant 400 during consecutive steps of a complete ‘suck’ cycle.

First, shown in FIG. 4A, a ‘teat’ 404 is formed from a nipple 406 and much of the areola 408, with wide milk ducts 410 containing milk 420, which lie behind the nipple 406, being drawn with the breast tissue into the mouth of the infant 400. The shape of the tongue 412 at the back represents its position at rest, cupped around the tip of the nipple 406.

The suck cycle is initiated by a welling up of the anterior tip 414 of the tongue 412, which is illustrated in FIG. 4B. At the same time, the lower jaw 416 is raised to constrict the base of the nipple 406, thereby ‘pinching off’ milk 420 within the ducts 410 of the teat 404.

The wave of compression 413 by the tongue 412 moves along the underside of the nipple in a posterior direction, pushing against the hard palate 418 as illustrated in FIG. 4C. This roller-like action squeezes milk from the nipple 406. The posterior portion 422 of the tongue 412 may be depressed as milk collects in the oropharynx 428.

In FIG. 4D and FIG. 4E the wave of compression 413 passes back at the tip of the nipple and pushes against the soft palate 424. As the tongue impinges on the soft palate 424 the levator muscles of the palate contract raising it to seal off the nasal cavity 426. Milk is pushed into the oropharynx 428 and is swallowed if sufficient has collected.

The cycle of compression continues in FIG. 4F and ends at the posterior base 430 of the tongue. Depression of the back portion of the tongue 412 creates negative pressure drawing the nipple and its milk contents once more into the mouth. This is accompanied by a lowering of the jaw 416 which allows milk 420 to flow back into the nipple 406. Compression by the tongue 412 and negative pressure within the mouth, maintain the tongue 412 in close conformation to the nipple 406 and palate 418, 424.

A computer program may be stored/distributed on a suitable medium, such as an optical storage medium or a solid-state medium, supplied together with or as part of other hardware, but may also be distributed in other forms, such as via the Internet or other wired or wireless telecommunication systems including being downloadable or purchasable via an app store.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

1. A breastfeeding supporting system, comprising:
a nipple shield adapted to be positioned at least partly over the areola and nipple of a breast of a breastfeeding woman,
a capacitive pressure sensing unit for sensing a capacity of at least part of a surface of the nipple shield,
an accelerometer unit for measuring an acceleration of the nipple shield, and
a processing unit adapted to process the sensed capacity and the measured acceleration of the nipple shield to derive at least one parameter of an infant interacting with the nipple of the breastfeeding woman.

2. The breastfeeding supporting system according to claim 1, wherein the processing unit is configured to derive a position of the mouth of the infant latching on the nipple of the breastfeeding woman as one of the parameters and to evaluate the position with respect to a correct position.

3. The breastfeeding supporting system according to claim 1, wherein the accelerometer unit is embedded in a wall of the nipple shield.

4. The breastfeeding supporting system according to claim 1, wherein the nipple shield comprises a visible orientation indication, wherein the accelerometer unit has a predetermined orientation relative to the visible orientation indication, and wherein the visible orientation indication is visible by the breastfeeding woman in case the nipple shield is positioned correctly on the areola.

5. The breastfeeding supporting system according to claim 1, wherein at least one of the capacitive pressure sensing unit and the accelerometer unit comprises a microelectromechanical systems based sensor component.

6. The breastfeeding supporting system according to claim 1, wherein none of the capacitive sensor unit the accelerometer unit and the processing unit protrudes from the surface of the nipple shield.

7. The breastfeeding supporting system according to claim 1, wherein the processing unit is configured to determine, based on the sensed surface capacity and the determined accelerations, at least one of i) a shape of the mouth of the infant latching on the nipple, ii) a quantitative measure of tongue tie of the infant and iii) a movement of the tongue of the infant.

8. The breastfeeding supporting system according to claim 1, further comprising a feedback unit for providing a feedback signal to the breastfeeding woman, wherein the feedback signal is indicative of at least one of i) status of nipple latching, ii) tongue tie, iii) the infant's feeding state and iv) suction strength.

9. The breastfeeding supporting system according to claim 8, wherein the feedback unit comprises a wireless transmission component for wirelessly transmitting at least the feedback signal, wherein the breastfeeding supporting system preferentially further comprises a user interface device for wirelessly receiving the feedback signal from the wireless transmission component and for providing a signal to the breastfeeding woman corresponding to the feedback signal.

10. The breastfeeding supporting system according to claim 8, further comprising a learning unit for correlating the feedback signal with a marker indicative of a well-being of the infant or the mother, and for deducing a quality of latching, suckling and/or positioning of the baby based on the correlation.

11. The breastfeeding supporting system according to claim 1, further comprising a power providing unit for providing power, wherein the power providing unit comprises an energy harvesting unit for mechanically harvesting energy from the nipple movement during suckling of the infant.

12. The breastfeeding supporting system according to claim 1, further comprising a stimulation unit for providing at least one of acoustical and optical stimuli, the stimuli preferentially comprising recorded sounds or videos of the infant, wherein the stimulation unit is configured to provide stimuli in reaction to a trigger event.

13. The breastfeeding supporting system according to claim 1, further comprising at least one of:
a breast pump, wherein a vacuum profile of the breast pump is configured to be adjusted based on the derived parameter of the infant,
a data storage unit for storing permanent and temporary data, and
a power switch provided in contact with the nipple shield.

14. A breastfeeding supporting method, the method comprising the steps of:
providing a sensed capacity with a capacitive pressure sensing unit of at least part of a surface of a nipple shield positioned on a nipple of a breastfeeding woman,
characterized in that the method further comprises:
providing a measured acceleration of the nipple shield with an accelerometer unit, and
processing the sensed capacity and the measured acceleration of the nipple shield with a processing unit to derive at least one parameter of an infant latching on the nipple of the breastfeeding woman.
